(19) United States
(12) Patent Application Publication
(10) Pub. No.: US 2006/0141390 A1
(43) Pub. Date: Jun. 29, 2006

(54) Composition for coating a photoresist pattern

(75) Inventors: Geun Su Lee, Gyeonggi-Do (KR); Seung Chan Moon, Gyeonggi-Do (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HYNIX SEMICONDUCTOR INC., Icheon-shi (KR)

(21) Appl. No.: 11/126,042

(22) Filed: May 10, 2005

(30) Foreign Application Priority Data
Dec. 28, 2004 (KR) 10-2004-0113862

(51) Int. Cl. G03C 1/76

(52) U.S. Cl. 430/270.1

(57) ABSTRACT

A composition for coating a photoresist pattern includes water and a compound including a repeating unit represented by Formula 1. The composition is coated on a previously formed pattern, thereby effectively reducing a size of a space or contact hole of photoresist pattern. A method for forming a photoresist pattern using the composition is usefully applied to all semiconductor processes for forming a fine pattern. 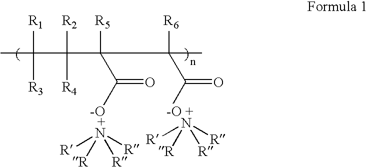
wherein R₁ to R₆, R′, R″ and n are defined in the specification.

### BACKGROUND

1. Technical Field

The disclosure relates to a composition for coating a photoresist pattern and a method for forming a fine photoresist pattern using the same. More specifically, the disclosure relates to a composition for coating a photoresist pattern which comprises water and a water-soluble polymer to form a fine contact hole and a method for forming a fine pattern using the same.

2. Disclosure of the Related Art

During formation of a contact hole in a semiconductor fine pattern, a resist flow process or a resist enhancement lithography assisted by chemical shrink (hereinafter, referred to as “RELACS”) process has been generally introduced to form a fine contact hole.

In the resist flow process, an exposure process and a developing process are carried out to form a photoresist pattern, and heat is applied to raise the temperature above the glass transition temperature of the photoresist so that the photoresist may flow thermally. The previously formed pattern has been gradually reduced by the supplied heat energy, so that a fine pattern as required in an integrated process is obtained as shown in FIG. 1.

In addition, even when uniform thermal energy is transmitted over the entire surface of the photoresist during the RFP, the photoresist flows from the upper portion and the lower portion more rapidly than from the middle portion. As a result, the profile of the pattern can be bent or collapsed and therefore non-vertical. Moreover, the pattern or contact hole may be filled due to an over-flowing during by the RFP.

The above phenomena such as deflection, collapse and fill of the pattern is exacerbated when the temperature is not accurately controlled and the flow time becomes longer than a predetermined value as the photoresist is sensitive to the applied heat.

In order to solve the above-described problems, a method of increasing temperature uniformity of a bake oven which applies heat or of precisely regulating time maintained at the bake oven has been used. However, the improvement degree of the oven process cannot overcome the above-described over-flow problem, and the regulation of the oven cannot improve the bent or non-vertical pattern.

Meanwhile, in a RELACS process, a common contact hole photoresist pattern 23 having a contact opening which is larger than a final contact hole to be formed is formed on underlying layer 22 formed on a substrate 21 and then a water-soluble polymer 24 is coated on the initial photoresist pattern 23. The water-soluble polymer 24 reacts with the photoresist pattern 23, so that an insoluble cross-linking layer is formed along the surface of the pattern. Thereafter, the photoresist pattern is washed to remove the unreacted polymer. As a result, the effective size of the photoresist pattern increases by the cross-linking layer 25 to reduce a space in a contact opening or a L/S pattern (see FIG. 2).

However, although the RELACS process can uniformly reduce a predetermined size regardless of a duty ratio, residuals remain in the pattern due to the incomplete removal of the water-soluble polymer. These residuals increase defects in a final device during subsequent etch process, which degrades yield of reliability of the device.

In addition, although the amount of residual material which remains on a wafer can be decreased by a 2-step process for cleaning the wafer with a first cleaning solution and then with water, the procedure becomes more complicated, adds at least one additional step and therefore the cost increases.

### SUMMARY OF THE DISCLOSURE

The disclosure provides a composition for coating a photoresist pattern, which comprises a water-soluble polymer and water. The disclosed composition can be formed a coating film along the surface of the photoresist pattern coated on a previously formed photoresist pattern.

Also, there is provided a method for forming a photoresist pattern using the disclosed composition, and a semiconductor device manufactured by the method.

Additional features and advantages may become apparent to those skilled in the art from a review of the following description, taken in conjunction with the drawing figures, the examples, and the appended claims.

### BRIEF DESCRIPTION OF THE DRAWINGS

FIG. 1 is a schematic diagram illustrating a conventional resist flow process to reduce a width of a photoresist pattern.

FIG. 2 is a schematic diagram illustrating a conventional RELACS process to reduce a width of a photoresist pattern.

FIG. 3 is a schematic diagram illustrating a process using a disclosed composition for coating a photoresist pattern to reduce a width of a photoresist pattern.

FIG. 4 is a photograph showing a photoresist pattern obtained from Comparative Example.

FIG. 5 is a photograph showing a photoresist pattern obtained from Example 3.

FIG. 6 is a photograph showing a photoresist pattern obtained from Example 4.

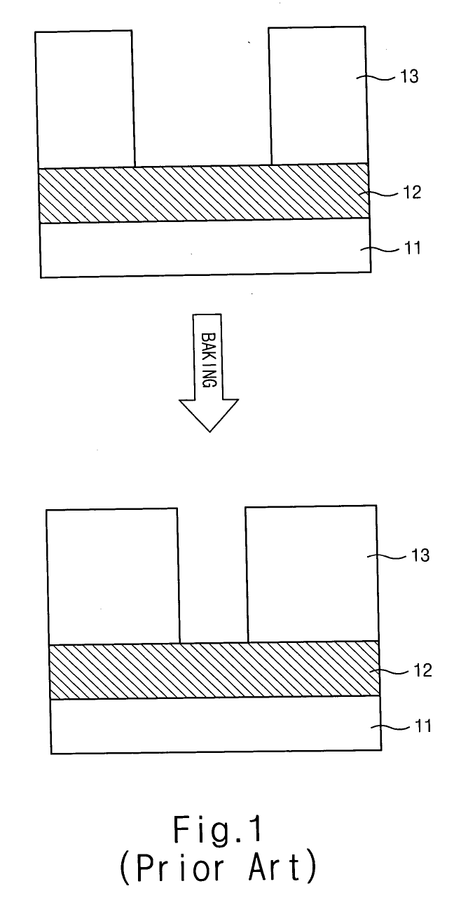

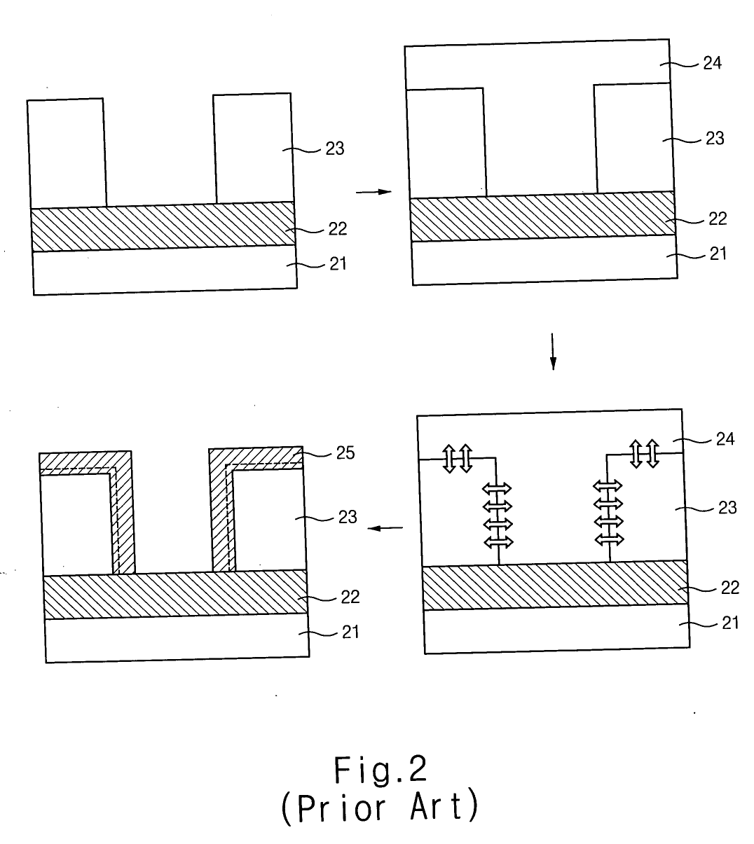

This disclosure and drawings are intended to be illustrative, and are not intended to limit the appended claims to the specific embodiments described herein.

### DETAILED DESCRIPTION OF THE PRESENTLY PREFERRED EMBODIMENTS

A composition for coating a photoresist pattern is disclosed. The disclosed composition can be formed a coating film along the surface of the pattern coated on a previously formed photoresist pattern.

The composition comprises water (H₂O) and a water-soluble polymer including a repeating unit of Formula 1:

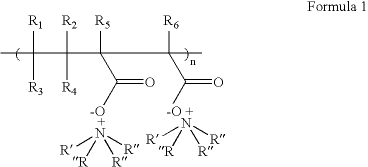

wherein R₁ to R₆ are individually selected from the group consisting of H, C₁-C₁₀ alkyl, a halogen element such as F, Cl, Br and I, and a —CN group;

R′ and R″ are individually selected from the group consisting of H, C₁-C₂₀ alkyl and C₇-C₂₀ alkylaryl; and

n is an integer ranging from 10 to 3,000.

Preferably, the R′ and R″ are selected from the group consisting of methyl, ethyl, propyl, butyl, octyl, octyl phenyl, nonyl, nonyl phenyl, decyl, decyl phenyl, undecyl, undecyl phenyl, dodecyl and dodecyl phenyl. The n is not limited herein.

Also, the water is preferably distilled water.

The water-soluble polymer including the repeating unit of Formula 1 may be poly[(isobutylene-alt-maleic acid)ammonium salt] represented by Formula 2 or poly[(isobutylene-alt-maleic acid)trimethylamine salt] represented by Formula 3.

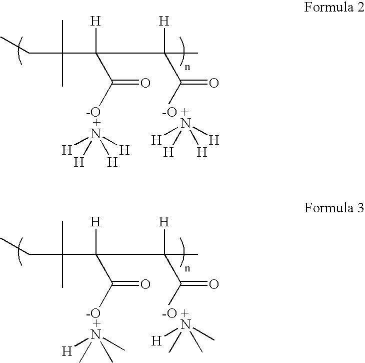

wherein n is an integer ranging from 10 to 3,000.

The disclosed composition is coated on an existing photoresist pattern to form a water-soluble polymer film, thereby reducing a size of space or hole of internal photoresist pattern.

In order to achieve the above-described objects, the disclosed composition should preferably have the following characteristics:

(1) will riot damage a photoresist pattern while coating the disclosed composition;

(2) have excellent adhesion property so that a composition film may be thinly coated on a surface of the photoresist pattern and an exposed surface of bottom layer of a photoresist patter when the disclosed composition is coated;

(3) have same or better etching resistance than that of existing photoresist;

(4) not foam on the surface of the composition film when the disclosed composition is coated; and

(5) have a vertical pattern profile after coating composition.

Preferably, the compound of Formula 1 is present in an amount of about 2 wt % or less based on the composition. That is, the relative ratio of the compound of Formula 1: water in disclosed composition is in the range of 0.0001˜2 wt %: 98˜99.9999 wt %. A capacity for forming a coating film on a photoresist film is deteriorated if the compound of Formula 1 is present in an amount of less than 0.0001 wt %, and the positive effects is almost constant if the compound of Formula 1 is present in an amount of more than 2 wt %. Therefore, an excess of 2 wt % can be wasteful.

In order to improve solubility and coating characteristics, the disclosed composition may further comprise a component selected from the group consisting of an alcohol compound, a surfactant and mixtures thereof.

The alcohol compound is present in an amount of 20 wt % and less, preferably 10 wt % and less, based on the composition. The surfactant is present in an amount of 2 wt % and less based on the composition. When the alcohol compound is present in an amount of more than 20 wt %, the photoresist film is dissolved in the alcohol, so that the pattern can be deformed. When the surfactant is present in an amount of more than 2 wt %, the width of the pattern is largely reduced, so that a desired coating characteristic may not be obtained.

Here, the alcohol compound is C₁-C₁₀ alkyl alcohol or C₂-C₁₀ alkoxy alcohol. Preferably, the alkyl alcohol is selected from the group consisting of methanol, ethanol, propanol, iso-propanol, n-butanol, sec-butanol, t-butanol, 1-pentanol, 2-pentanol, 3-pentanol, 2,2-dimethyl-1-propanol and mixtures thereof. The alkoxy alcohol is selected from the group consisting of 2-methoxyethanol, 2-(2-methoxyethoxy)ethanol, 1-methoxy-2-propanol, 3-methoxy-1,2-propandiol and mixtures thereof.

Also, any of surfactants that are dissolved in water can be used, which are not limited in specific kinds.

In the disclosed composition, the relative ratio of compound of Formula 1: alcohol compound: water in the disclosed composition is preferably in the range of 0.0001˜2 wt %: 0.0001˜10 wt %: 88˜99.9998 wt %.

The disclosed composition can be obtained by filtering a mixture solution comprising water and the compound of Formula 1 or a solution further comprising an alcohol compound in the mixture solution in a filter, preferably, 0.2 μm filter. The disclosed composition can be applied to all processes for forming a photoresist pattern.

Additionally, a method for forming a photoresist pattern comprises:

(a) coating photoresist composition on an underlying layer formed on a semiconductor substrate to form a photoresist film;

(b) exposing the photoresist film to light;

(c) developing the exposed photoresist film to obtain a photoresist pattern, and

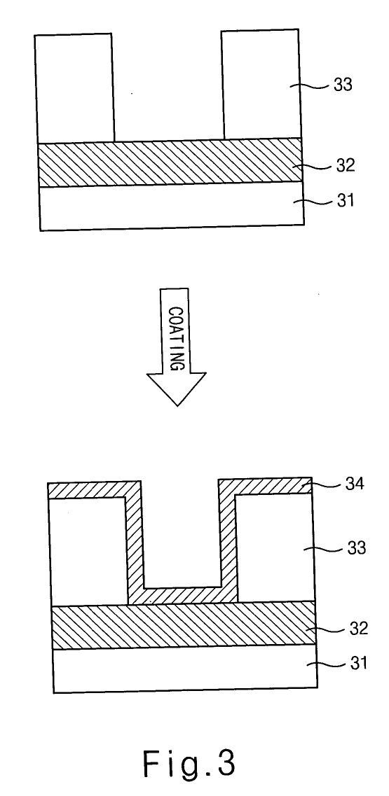

(d) coating the disclosed composition for coating a photoresist on the photoresist pattern as shown in FIG. 3.

The method may further comprise a baking process the photoresist film either before or after the exposing step (b). The baking process is preferably performed at a temperature ranging from about 70° C. to about 200° C.

The exposure process is performed using the source of light selected from the group consisting of KrF (248 nm), ArF (193 nm), VUV (157 nm), EUV (13 nm), E-beam, X-ray and ion beam, and the exposure process is performed at an exposure energy ranging from about 0.1 mJ/cm² to about 100 mJ/cm².

The developing process is performed with an alkali developing solution which is preferably TMAH aqueous solution of about 0.01 wt % to about 5 wt %.

Also, there is provided a semiconductor device manufactured by the method for forming a photoresist pattern using the disclosed composition.

The disclosed compositions will be described in detail by referring to examples below, which are not intended to limit the present invention.

### Example 1

### Preparation of a Disclosed Composition for Coating a Photoresist Pattern (1)

Water (100 g) was added to poly[(isobutylene-alt-maleic acid)ammonium salt] represented by Formula 2 having an average molecular weight of 160,000 (produced by Aldrich Co.) (0.5 g). The resulting mixture was stirred for 60 minutes, and then filtered through a 0.2 μm filter to obtain a disclosed composition for a photoresist pattern.

### Example 2

### Preparation of a disclosed Composition for Coating a Photoresist Pattern (2)

The procedure of Example 1 was repeated except using poly[(isobutylene-alt-maleic acid)trimethylamine salt] represented by Formula 3 having an average molecular weight of 163,000 (0.5 g) instead of the poly[(isobutylene-alt-maleic acid)ammonium salt] of Example 1.

### Comparative Example

### General Pattern Process

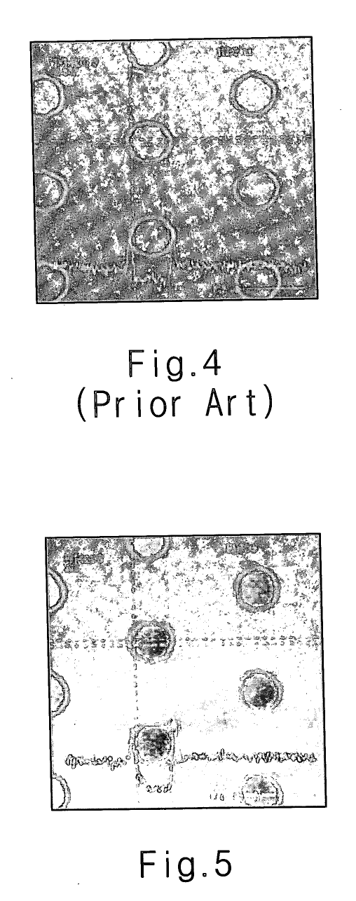

An underlying layer was formed on a silicon wafer treated with HMDS, and a methacrylate type photoresist (“TarF-7a-39” produced by TOK Co.) was spin-coated thereon to form a photoresist film at a thickness of 3,500 Å. Then, the photoresist film was soft-baked at about 130° C. for about 90 seconds. After baking, the photoresist film was exposed to light using an ArF laser exposer, and post-baked at about 130° C. for about 90 seconds. When the post-baking was completed, it was developed in 2.38 wt % aqueous TMAH solution for about 30 seconds, to obtain 112 nm contact hole pattern (see FIG. 4).

### Example 3

### Formation of a Pattern using a Disclosed Composition (1)

10 ml of the disclosed composition obtained from Example 1 was coated on the 112 nm contact hole pattern obtained from Comparative Example to obtain 90 nm contact hole pattern (FIG. 5).

### Example 4

### Formation of a Pattern using a Disclosed Composition (2)

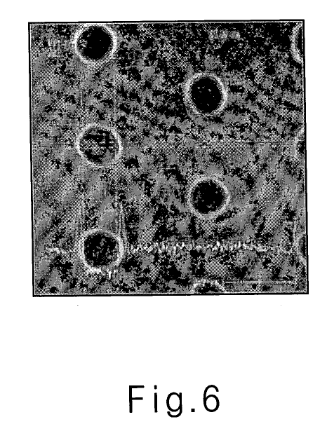

10 ml of the disclosed composition obtained from Example 2 was coated on the 112 nm contact hole pattern obtained from Comparative Example to obtain 91 nm contact hole pattern (FIG. 6).

As described above, the size of a space or contact hole of photoresist pattern can be effectively reduced when the disclosed composition for forming a photoresist pattern is coated on a previously formed photoresist pattern to obtain composition film. As a result, the disclosed composition for coating a photoresist pattern and a method for forming a fine pattern using the same can be usefully applied to all semiconductor processes for obtaining a fine contact hole.

What is claimed is:

1. A composition for coating a photoresist pattern comprising water and a water-soluble polymer including a repeating unit of Formula 1: 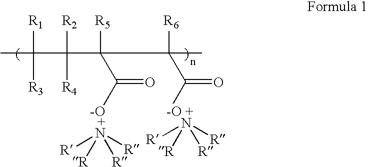
wherein R₁ to R₆ are individually selected from the group consisting of H, C_{1-C}₁₀ alkyl, a halogen element, and a —CN group;
R′ and R″ are individually selected from the group consisting of H, C₁-C₂₀ alkyl and C₇-C₂₀ alkylaryl; and
n is an integer ranging from 10 to 3,000.

2. The composition according to claim 1, wherein the R′ and R″ are individually selected from the group consisting of methyl, ethyl, propyl, butyl, octyl, octyl phenyl, nonyl, nonyl phenyl, decyl, decyl phenyl, undecyl, undecyl phenyl, dodecyl and dodecyl phenyl.

3. The composition according to claim 1, wherein the water-soluble polymer including the repeating unit of Formula 1 is a poly[(isobutylene-alt-maleic acid)ammonium salt] represented by Formula 2 or a poly[(isobutylene-alt-maleic acid)trimethylamine salt] represented by Formula 3: 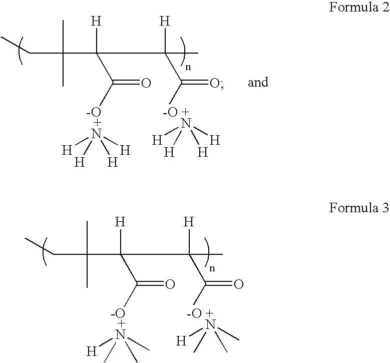
wherein n is an integer ranging from 10 to 3,000.

4. The composition according to claim 1, wherein the compound of Formula 1 is present in an amount of 2 wt % and less based on the composition.

5. The composition according to claim 1, wherein the composition further comprises a component selected from the group consisting of an alcohol compound, a surfactant and mixtures thereof.

6. The composition according to claim 5, wherein the alcohol compound is present in an amount of 20 wt % and less based on the composition.

7. The composition according to claim 6, wherein the alcohol compound is present in an amount of 10 wt % and less based on the composition.

8. The composition according to claim 5, wherein the alcohol compound is a C₁-C₁₀ alkyl alcohol or a C₂-C₁₀ alkoxy alcohol.

9. The composition according to claim 8, wherein the C₁-C₁₀ alkyl alcohol is selected from the group consisting of methanol, ethanol, propanol, iso-propanol, n-butanol, sec-butanol, t-butanol, 1-pentanol, 2-pentanol, 3-pentanol, 2,2-dimethyl-1-propanol and mixtures thereof.

10. The composition according to claim 8, wherein the C₂-C₁₀ alkoxy alcohol is selected from the group consisting of 2-methoxyethanol, 2-(2-methoxyethoxy)ethanol, 1-methoxy-2-propanol, 3-methoxy-1,2-propandiol and mixtures thereof.

11. The composition according to claim 5, wherein the surfactant is present in an amount of 2 wt % and less based on the composition.

12. A method for forming a photoresist pattern comprising:
(a) coating photoresist composition on an underlying layer formed on a semiconductor substrate to form a photoresist film;
(b) exposing the photoresist film to light;
(c) developing the exposed photoresist film to obtain a photoresist pattern; and
(d) coating the composition for coating a photoresist pattern of claim 1 on the photoresist pattern.

13. The method according to claim 12, further comprising a soft-baking process before the exposing of step (b) or a post-baking process after the exposing of step (b).

14. The method according to claim 12, wherein the light source of part (b) is selected from the group consisting of KrF (248 nm), ArF (193 nm), VUV (157 nm), EUV (13 nm), E-beam, X-ray and ion-beam.

15. A method for forming a photoresist pattern comprising:
(a) coating photoresist composition on an underlying layer formed on a semiconductor substrate to form a photoresist film;
(b) exposing the photoresist film to light;
(c) developing the exposed photoresist film to obtain a photoresist pattern; and
(d) coating the composition for coating a photoresist pattern of claim 5 on the photoresist pattern.

16. A semiconductor device manufactured by the method described in claim 12.

17. A semiconductor device manufactured by the method described in claim 13.

18. A semiconductor device manufactured by the method described in claim 14.

19. A semiconductor device manufactured by the method described in claim 15.
